(19) United States
(12) Patent Application Publication
(10) Pub. No.: US 2020/0398306 A1
(43) Pub. Date: Dec. 24, 2020

(54) COATING STRUCTURE, METHOD FOR FORMING COATING STRUCTURE AND VEHICLE WHEEL

(71) Applicant: TOPY KOGYO KABUSHIKI KAISHA, Tokyo (JP)

(72) Inventors: Masafumi BOJO, Tokyo (JP); Naoto URUSHIHATA, Tokyo (JP)

(21) Appl. No.: 16/097,756

(22) PCT Filed: May 18, 2017
(86) PCT No.: PCT/JP2017/018663

§ 371 Date: Oct. 30, 2018

(30) Foreign Application Priority Data
May 19, 2016 (JP) 2016-100535

(51) Int. Cl. B05D 1/38; B05D 3/06; B05D 5/06; B32B 15/08; B32B 3/30; B60B 3/00

(52) U.S. Cl. CPC B05D 1/38; B05D 3/06; B60B 3/00; B32B 15/08; B32B 3/30; B05D 5/06

(57) ABSTRACT

A coating structure that provides subtle changes of different tints in a similar color system and a pattern includes a base layer 12 laminated on a basis metal 11, a color layer 13 laminated on the base layer 12 and a clear layer 15 as an outermost layer laminated on the color layer 13. The base layer 12 and the color layer 13 present different colors. The base layer 12 has recesses 12a in specific regions 10x. The base layer 12 is thinner in the specific regions 10x than in the other regions 10y. The color layer 13 has protrusions 13a in the specific regions 10x filled in the recess 12a. The color layer 13 is thicker in the specific regions 10x than in the other regions 10y.

### FIELD OF THE INVENTION

The present invention relates to a coating structure formed on a basis metal, a method for forming the coating structure, and a vehicle wheel having the coating structure.

### BACKGROUND OF THE INVENTION

A coating structure formed on an aluminum vehicle wheel generally includes a base layer formed by powder coating, a color layer applied on the base layer and a transparent clear layer further applied on the color layer. Since the coating structure is thin, a color of the base layer underlying the color layer can be seen from outside in addition to a color of the color layer. However, the coating structure, having a solid color without patterns over the whole area, is poor in design.

Patent Document 1 given below discloses a method of forming a base layer and a color layer on a basis metal of a vehicle wheel made of aluminum alloy, then removing the base layer and the color layer in a specific region by a laser to expose the basis metal, and then forming a clear layer over the whole area. According to the method mentioned above, a shining surface region in which the basis metal is exposed and a colored region having a color presented by the base layer and the color layer are mixed, and design can be improved by a contrast between the colored region and the shining surface region.

### PRIOR ART DOCUMENTS

### Patent Documents

Patent Document 1: Japanese Unexamined Patent Application Publication No. 2009-29333

### SUMMARY OF THE INVENTION

### Problem to be Solved by the Invention

However, the vehicle wheel of the Patent Document 1 does not satisfy users' demands for enjoying subtle changes of tints and patterns.

### Solution to the Problem

To solve the problems mentioned above, one aspect of the present invention provides a coating structure including a plurality of layers laminated on a basis material, wherein a selected layer includes a recess or a missing portion in an outer surface thereof in a specific region, and a layer adjacent to the selected layer outside of the selected layer includes a protrusion filled in the recess or the missing portion in the specific region.

In a more specific aspect of the present invention, there is provided a coating structure including a base layer laminated on a basis metal, at least one layer of color layer laminated on the base layer and a clear layer as an outermost layer laminated on the color layer, wherein a selected layer of the base layer and the color layer includes recesses in an outer surface thereof in specific regions, and the color layer or the clear layer adjacent to the selected layer outside of the selected layer includes protrusions filled in the recesses in the specific regions.

In another more specific aspect of the present invention, there is provided a coating structure including a base layer laminated on a basis metal, at least one layer of color layer laminated on the base layer and a clear layer as an outermost layer laminated on the color layer, wherein a selected layer of the base layer and the color layer includes missing portions in specific regions and the color layer or the clear layer adjacent to the selected layer outside of the selected layer comprises protrusions filled in the missing portions in the specific regions.

According to the features mentioned above, a pattern can be drawn by the recesses and the protrusions in the specific regions, and the design can be improved.

Preferably, of the base layer and the at least one layer of color layer, two layers adjacent to each other present different colors, and one of the two layers adjacent to each other is provided as the selected layer.

According to the features mentioned above, the specific regions and the other regions have a different ratio of thicknesses of the layers that present different colors. Therefore, different tints of a similar color system can be presented, and the design can be further improved.

Preferably, the coating structure further includes a first color region and a second color region, wherein the first color region includes a plurality of the specific regions and the second color region does not include the specific region.

According to the features mentioned above, when seen closely, a pattern created by difference in tints between the specific regions and the other regions can be enjoyed in the first color region. When seen from a distance, a pattern created by difference in tints between the first color region and the second color region.

In a method for forming the coating structure, after laminating the selected layer, the recess or a missing portion is formed by irradiating laser on the selected layer in the specific regions, and the color layer or the clear layer is laminated thereafter.

According to the method mentioned above, recesses or missing portions having a variety of dimensions can be formed by the laser.

The coating structure may be formed on a design surface of a vehicle wheel.

### Advantageous Effects of the Invention

According to the present invention, a pattern of a similar color system appears, and the design can be improved.

### BRIEF DESCRIPTION OF THE DRAWINGS

FIG. 1 shows a front view showing a design surface of a vehicle wheel to which a coating structure of the present invention is applied.

FIG. 2 is an enlarged cross-sectional view of a coating structure according to a first embodiment of the present invention.

FIG. 3 is a further enlarged cross-sectional view of a second color region of the coating structure of FIG. 2.

FIG. 4 is a further enlarged cross-sectional view of a first color region of the coating structure of FIG. 2.

FIG. 5A is a cross-sectional view, showing a step of forming a base layer on a basis metal of a vehicle wheel by powder coating in a method for forming the coating structure.

FIG. 5B is a cross-sectional view, showing a step of forming a recess in the base layer by laser after the step shown in FIG. 5A.

FIG. 5C is a cross-sectional view, showing a step of laminating a color layer on the base layer after the step shown in FIG. 5B.

FIG. 6 is a graph showing results of measurements in an experimental example according to the first embodiment.

FIG. 7 is an enlarged cross-sectional view of a first color region of a coating structure according to a second embodiment of the present invention.

FIG. 8A is a cross-sectional view, showing a step of forming a first layer of a color layer on a base layer in a method for forming a coating structure according to a third embodiment of the present invention.

FIG. 8B is a cross-sectional view, showing a step of forming a second layer of the color layer on the first layer of the same color layer by masking after the step shown in FIG. 8A.

FIG. 8C is a cross-sectional view, showing a step of forming a clear layer after the step shown in FIG. 8B.

FIG. 9 is an enlarged cross-sectional view of a first color region of a coating structure according to a fourth embodiment of the present invention.

FIG. 10 is an enlarged cross-sectional view of a first color region of a coating structure according to a fifth embodiment of the present invention.

FIG. 11 is an enlarged cross-sectional view of a first color region of a coating structure according to a sixth embodiment of the present invention.

FIG. 12 is an enlarged cross-sectional view of a first color region of a coating structure according to a seventh embodiment of the present invention.

FIG. 13 is an enlarged cross-sectional view of a first color region of a coating structure according to an eighth embodiment of the present invention.

### DESCRIPTION OF THE PREFERRED EMBODIMENTS

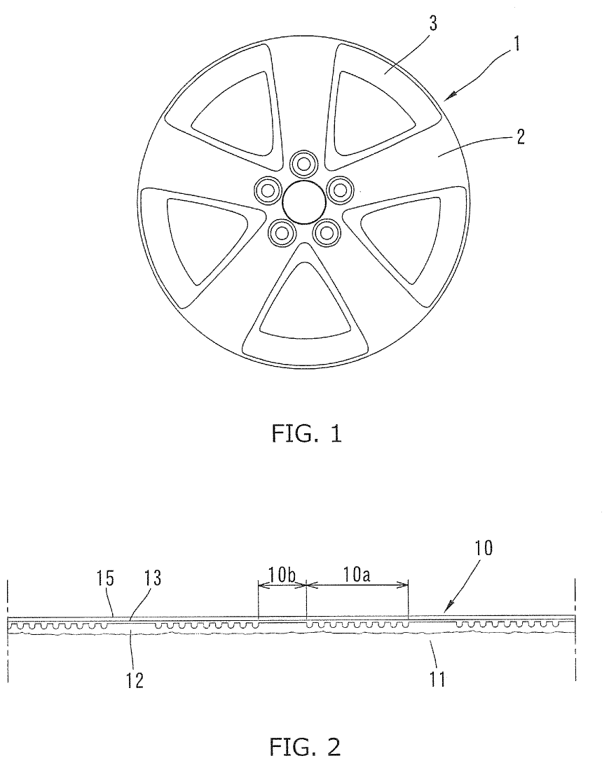

A first embodiment of the present invention will be described hereinafter with reference to the drawings. FIG. 1 shows a design surface (surface on an opposite side to a vehicle) of a vehicle wheel 1 obtained by casting aluminum alloy. In the design surface, a coating structure is formed in a surface region of a spoke 2 and a surface region surrounding a decorative opening 3.

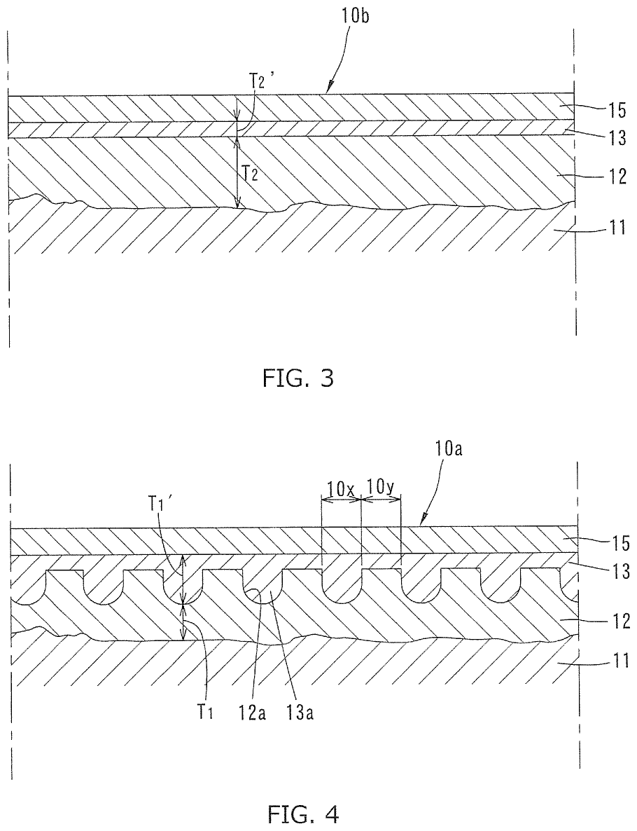

As shown in FIGS. 2 and 3, as with a standard vehicle wheel, the coating structure 10 includes a base layer 12 formed on a basis metal 11 by powder coating, a color layer 13 laminated on the base layer 12 by color coating and a transparent clear layer 15 laminated on the color layer 13 by clear coating. The base layer 12 and the color layer 13 have different colors. In this application, “color” includes black, white and gray in addition to red, yellow and blue or the like.

A pattern due to a change in tint is formed on the coating structure 10. Specifically, as shown in FIG. 2, a two dimensional pattern is formed by first color regions 10a and second color regions 10b. The first color regions 10a and the second color regions 10b have different tints due to different inner structures.

In the second color region 10b shown in FIG. 3, the color layer 13 and the clear layer 15 spread in generally homogeneous thicknesses. The second color region 10b presents a second color according to colors of the base layer 12 and the color layer 13 and a ratio of a thickness T₂ of the base layer 12 and a thickness Tz′ of the color layer 13.

As shown in FIG. 4, a multitude of linear specific regions 10x extending in a direction orthogonal to the page are disposed in the first color region 10a. In the specific region 10x, a groove, which is a linearly extending recess 12a, is formed in an outer surface of the base layer 12. A protrusion 13a filled in the recess 12a is formed in an inner surface of the color layer 13. Accordingly, a ratio of a thickness T₁ of a bottom portion of the base layer 12 and a thickness T₁′ of the color layer 13 in the specific region 10x is different from the one in the second color region 10b. The specific region 10x presents a first color that belongs to a similar color system to the second color but is different from the second color. In the region 10y other than the specific regions 10x of the first color region 10a, a ratio of a thickness of the base layer 12 and a thickness of the color layer 13 is generally same as that of the second color region 10b. Accordingly, the other region 10y presents the second color. A width of the recess 12a is about 50 microns, for example, but may be narrower or wider. The specific regions 10x may be dispersedly arranged in a dispersed dots configuration. In this case, the recess 12a is formed as a dot in each specific region 10x.

In the first color region 10a, the specific regions 10x are minute. When seen closely, difference in tints of the specific regions 10x and the other region 10y can be visually recognized. When seen from a distance, a color of the first color region 10a is visually recognized as a color obtained by mixing the colors of the regions 10x, 10y (first color+second color). In this way, a pattern of the first color regions 10a and the second color regions 10b having different tints in the similar color system can be enjoyed and a design of the vehicle wheel can be improved.

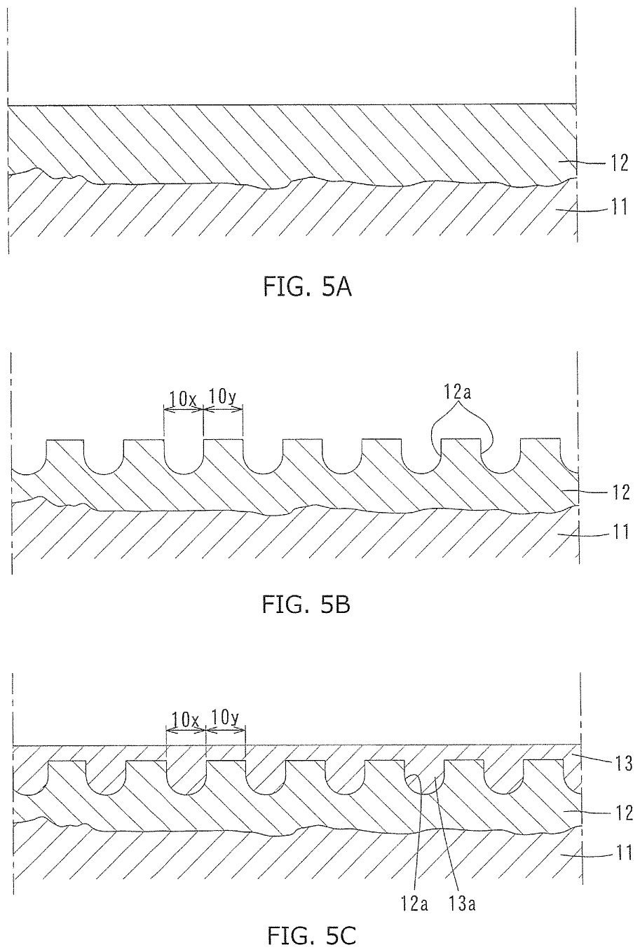

A method for forming the coating structure 10 is described below with reference to FIGS. 5A to 5C.

As shown in FIG. 5A, the base layer 12 is formed by making a surface of the basis metal 11 of the vehicle wheel 1 rough and by powder coating and baking. An outer surface of the base layer 12 is smooth.

Next, as shown in FIG. 5B, the recess 12a is formed in the specific regions 10x of the first color regions 10a on the outer surface of the base layer 12 by irradiating laser beams.

Next, as shown in FIG. 5C, the color layer 13 is formed by coating and baking a color coating material. Since the color coating material fills the recess 12a of the base layer 12 when the color coating material is coated, the color layer 13 has a protrusion 13a filled in the recess 12a.

Finally, as shown in FIG. 4, the clear layer 15 is formed by coating and baking a clear coating material.

### Experimental Example

A coating structure actually formed in the method described above was cut and layer thicknesses in the specific region 10x (laser-irradiated portion) and the region 10y (non-laser-irradiated portion) adjacent to each other were measured using a micrograph, and the results shown in Table 1 were obtained.

TABLE 1

| | laser-irradiated | non-laser-irradiated | |
|---|---|---|---|
| | portion | portion | difference |
| base layer | 63.1 | 99.6 | −36.5 |
| color layer | 46.5 | 12.9 | 33.6 |
| clear layer | 27.0 | 24.5 | 2.5 |
| total | 136.6 | 137.0 | −0.4 |

unit: μm

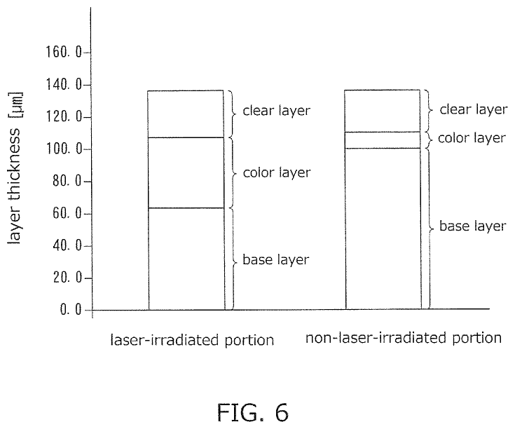

FIG. 6 is a graphic representation of Table 1.

The results of measurement confirm that a recess 12a of a base layer 12 formed by laser is fully filled with a protrusion 13a of a color layer 13 and that the layer thicknesses of the regions 10x and 10y are almost unchanged in spite of the forming of the recess 12a and a surface of the coating structure 10 is smooth.

Other embodiments of the present invention will be described hereinafter with reference to drawings. In the drawings, same reference numerals will be used to indicate features corresponding to those of the foregoing embodiments, and explanation thereof will be omitted.

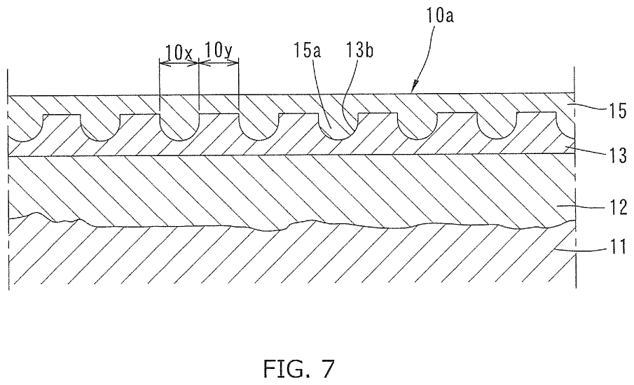

In a second embodiment shown in FIG. 7, a groove, which is a linearly extending recess 13b, is formed by laser in a color layer 13 in a specific region 10x of a first color region 10a instead of forming a recess in a base layer 12. A clear coating material fills the recess 13b, and thereby, a protrusion 15a is formed in a clear layer 15. The recess 13b is not formed in a second color region that is not shown, and a ratio of thicknesses of the layers 12, 13, 15 is similar to the one in a region 10y. Widths of the regions 10x, 10y can be controlled by conditions of laser processing. The recesses 13b may be dispersedly formed in a dispersed dots configuration.

Also in the second embodiment mentioned above, since a thickness of the color layer 13 in the specific region 10x of the first color region 10a is different from a thickness of the other region 10y of the first color region 10a and the one in the second color region, the specific region 10x presents a color that belongs to a similar color system to but has different tint from those in the region 10y and the second color region 10b.

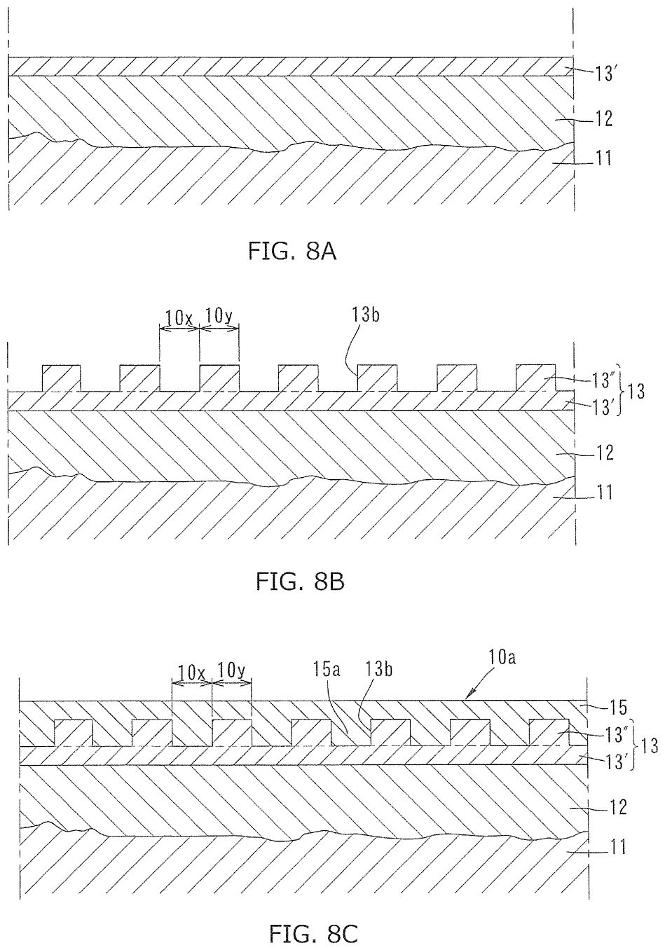

In a third embodiment shown in FIGS. 8A to 8C, a recess 13b is formed in a color layer 13 by masking instead of by laser. Specifically, as shown in FIG. 8A, a first layer 13′ of the color layer 13 is formed on a base layer 12. Next, as shown in FIG. 8B, a second layer 13″ of the same color layer is formed with a specific region 10x of the first layer 13′ masked. As a result, the color layer 13 having the recess 13b can be obtained by the first layer 13′ and the second layer 13″. After that, a clear layer 13 is formed as shown in FIG. 8C. Thereby, a coating structure similar to the one in the second embodiment shown in FIG. 7 can be obtained.

In the first embodiment, the recess 12b may be formed in the base layer 12 by masking instead of by laser. In this step, after forming a first layer of the base layer 12, a second layer of the base layer is formed with the specific region masked.

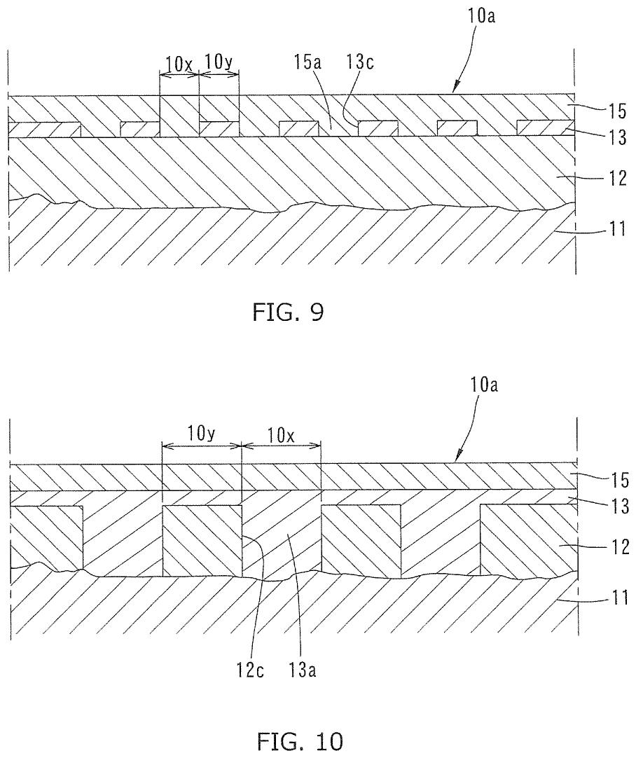

In a fourth embodiment shown in FIG. 9, a groove or a hole 13c (missing portion) passing through a color layer 13 is formed in the color layer 13 by laser or by masking in a specific region 10x of a first color region 10a. A protrusion 15a of a clear layer 15 is filled in the groove or the hole 13c. In this embodiment, a color of a base layer 12 appears in the specific region 10x of the first color region 10a and a color obtained by mixing a color of the base layer 12 and a color of the color layer 13 appears in the other region 10y of the first color region 10a and in the second color region 10b. In this embodiment, a pattern having different tints in the similar color system that have stronger contrast than those in the first and second embodiments can be obtained.

In a fifth embodiment shown in FIG. 10, a groove or a hole 12c (missing portion) passing through a base layer 12 is formed in the base layer 12 by laser in a specific region 10x of a first color region 10a. A protrusion 13a of a color layer 13 is filled in the hole 12c. In this embodiment, a color of the color layer 13 appears in the specific region 10x of the first color region 10a and a color obtained by mixing a color of the base layer 12 and a color of the color layer 13 appears in the other region 10y of the first color region 10a and in a second color region. In this embodiment, a pattern having different tints in the similar color system that have stronger contrast than those in the first and second embodiments can be obtained.

The present invention can be applied to a coating structure having a plurality of color layers.

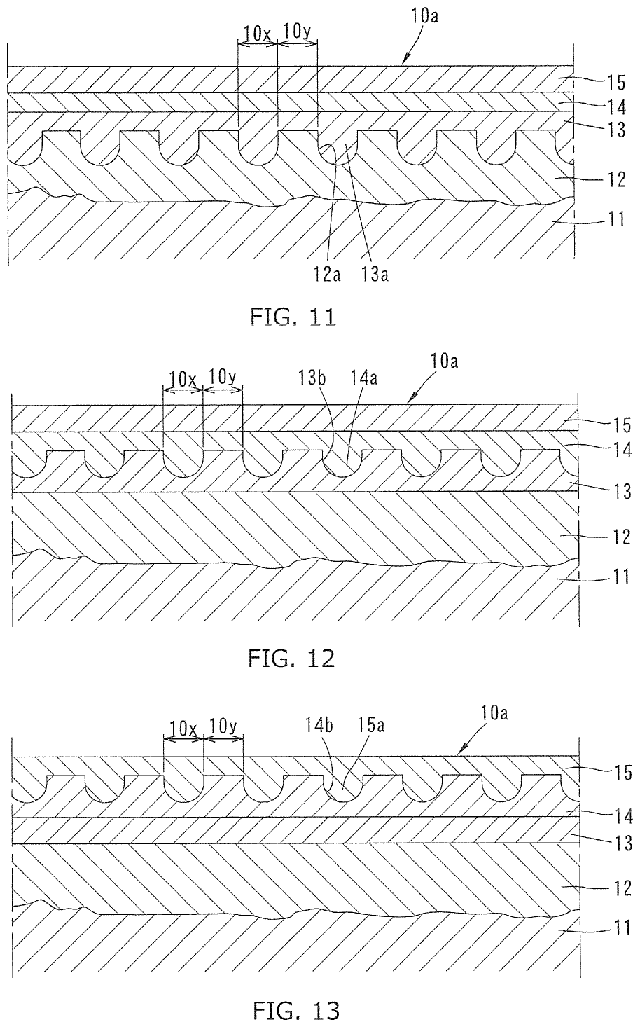

In a sixth embodiment shown in FIG. 11, two color layers 13, 14 are laminated between a base layer 12 and a clear layer 15, and the base layer 12 and the color layers 14, 15 present different colors.

In this embodiment, a recess 12a is formed in the base layer 12 by laser in a specific region 10x of a first color region 10a and a protrusion 13a to be filled in the recess 12a is formed in the inner color layer 13. In the specific region 10x, a ratio of a thickness of the base layer 12 and a thickness of the inner color layer 13 is different from those in the other region 10y and in the second color region.

In a seventh embodiment shown in FIG. 12, a recess 13b is formed in an inner color layer 13 by laser in a specific region 10x of a first color region 10a and a protrusion 14a to be filled in the recess 13b is formed in an outer color layer 14. In the specific region 10x, a ratio of a thickness of the inner color layer 13 and a thickness of the outer color layer 14 is different from those in the other region 10y and in the second color region.

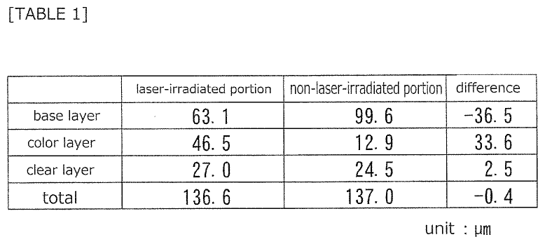

In an eighth embodiment shown in FIG. 13, a recess 14b is formed in an outer color layer 14 by laser in a specific region 10x of a first color region 10a and a protrusion 15a to be filled in the recess 14b is formed in a clear layer 15. A thickness of the outer color layer 14 of the specific region 10x is different from that of the other region 10y and the second color region.

In the embodiments shown in FIGS. 11 to 13, a groove or a hole (missing portion) passing through a selected layer may be formed by laser in place of the recess 12a, 13b, 14b.

The present invention is not limited to the embodiments described above, and various embodiments can be adopted. For example, the coating structure may be composed only of the first color region 10a of the embodiments given above. Even in this case, a change in a tint between a specific region 10x and the other region 10y can be enjoyed.

In the first color region 10a, small specific regions 10x may be homogeneously dispersedly arranged or a density thereof may be varied. In the latter case, a gradational effect can be obtained, for example, by making a density of the specific regions 10x high in a middle portion of the first color region 10a and making the density lower toward a peripheral portion.

A plurality of the specific regions 10x are disposed in the first color region 10a in the embodiments mentioned above, an entirety of the first color region 10a may be provided as a specific region and a recess, a groove or a hole having a large area may be formed in a selected layer. In a case of a recess, a gradational effect may be obtained by making the recess deeper in a middle portion of the region and shallower toward a peripheral portion.

The coating structure may have three or more kinds of color regions. For example, the first and second color regions may be the same as those of the embodiments mentioned above and an entirety of a third color region may be provided as a specific region and a recess, a groove or a hole having a large area may be formed in a selected layer. In this way, an intricate pattern may be obtained in three or more kinds of color regions having different tints in a similar color system.

Similarly, when a coating structure has three or more kinds of color regions, besides the two color regions similar to those in FIG. 3 and FIG. 4, for example, the coating structure may have a color region similar to one of the first color regions in FIGS. 7 to 9.

The coating structure may have a layer including a metallic flake besides the color layer between the base layer and the clear layer. The layer including the metallic flake is very thin compared with the other layers, having a thickness of not more than 1 micron. In a case where the layer including the metallic flake is laminated on a selected layer in which a recess or a hole may be formed, after forming the recess or the hole by laser irradiation, the layer including the metallic flake may be formed. In this case, the layer including the metallic flake is disposed between the recess or the hole and the protrusion. Alternatively, the recess or the hole may be formed by laser irradiation after forming the layer including the metallic flake in the selected layer. In this case, the layer including the metallic flake is not disposed between the recess or the hole and the protrusion.

When a multiple layers of color layers are disposed, only two layers of layer s adjacent to each other may present different colors, and one of the two layers of the layers may be provided as a selected layer and a recess, a groove or a hole may be formed in the selected layer.

In the first to the fourth embodiments, the base layer and the color layer may have a same color, black, for example. In this case, even with colors of a similar color system, boundaries between the recess, the groove or the hole and the protrusion appear as a pattern, and design can be improved.

Similarly, in a coating structure having a plurality of color layers as shown in FIGS. 10 to 12, a layer having a recess, a groove or a hole and a layer having a protrusion may have a same color.

It is not required that a protrusion should fully fill a recess or a missing portion.

An outer surface of a coating structure, which is an outer surface of a clear coating structure, may have gentle undulations due to concavities and convexities of an inner layer.

A Yb laser beam may be used. Alternatively, a variety of other laser beams may be used.

The recess, the groove or the hole may be formed by cutting or masking or other methods.

The coating structure of the present invention may be formed on a basis metal other than the design surface of the vehicle wheel. Alternatively, the coating structure of the present invention may be applied to a basis material other than metal.

The present invention may be applied to a laminate structure of any kind of layers, not limited to the base layer, the color layer and the clear layer in the embodiments mentioned above.

### INDUSTRIAL APPLICABILITY

The present invention may be applied to a coating structure of a vehicle wheel or the like.

1. (canceled)

2. A vehicle wheel having a coating structure on a design surface thereof, the coating structure comprising:
a base layer laminated on a basis metal;
at least one layer of color layer laminated on the base layer; and
a clear layer as an outermost layer laminated on the at least one layer of color layer,
wherein the at least one layer of color layer comprises an adjacent color layer adjacent to the base layer,
the base layer comprises recesses in an outer surface thereof in specific regions,
the adjacent color layer comprises protrusions fully filled in the recesses in the specific regions,
a thickness of the base layer is thinner in the specific region than in the other region,
a thickness of the adjacent color layer is thicker in the specific region than in the other region, and
a ratio of thickness of the base layer and the adjacent color layer in the specific region is different from a ratio of thickness of the base layer and the adjacent color layer in the other region.

3. The vehicle wheel according to claim 2, wherein of the base layer and the adjacent color layer present different colors.

4. The vehicle wheel according to claim 2, wherein the coating structure further comprises:
a first color region; and
a second color region,
wherein the first color region includes a plurality of the specific regions and the second color region does not include the specific region.

5-10. (canceled)

11. The vehicle wheel according to claim 4, wherein the specific regions extend linearly and the recesses are provided as grooves in the first color region.
